(19) United States
(12) Patent Application Publication
(10) Pub. No.: US 2010/0118804 A1
(43) Pub. Date: May 13, 2010

(54) WIRELESS PACKET COMMUNICATION SYSTEM AND RESOURCE SCHEDULING METHOD THEREOF

(75) Inventors: Kang-Hee Kim, Busan (KR); Geon-Min Yeo, Daejeon (KR); Byung-Han Ryu, Daejeon (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMUNICATIONS RESEARCH INSTITUTE, Daejeon (KR); SAMSUNG ELECTRONICS CO., LTD., Suwon-si (KR)

(21) Appl. No.: 12/532,597

(22) PCT Filed: Mar. 26, 2008
(86) PCT No.: PCT/KR08/01693

§ 371 Date: Sep. 22, 2009

(30) Foreign Application Priority Data
Mar. 26, 2007 (KR) 10 2007 0029072

(51) Int. Cl. H04W 64/00

(52) U.S. Cl. 370/329

(57) ABSTRACT

According to the present invention, a wireless packet communication system having a protocol structure that can improve radio resource efficiency while reducing the amount of control information in packet transmission for radio resource allocation to a mobile station, and a radio resource allocation method of the system, is provided.

### TECHNICAL FIELD

The present invention relates to a wireless packet communication system and a radio resource allocation method thereof. More particularly, it relates to a wireless packet communication system and a radio resource allocation method of the system having a protocol structure for improving radio resource efficiency while reducing the amount of control information for packet transmission when radio resource allocation is performed to a mobile station.

This work was supported by the 3G Evolution wireless transmission R&D program of MIC/IITA [2005-S-404-13, Research & Development of Radio Transmission Technology for 3G evolutio].

### BACKGROUND ART

With the introduction of a wireless packet communication system, research and development for realization of the wireless packet communication system have been accelerated. On the other hand, with the development of the wireless packet communication system, radio resource allocation for supporting a persistent data service has been requested. The persistent data service is a data service for transmitting a data packet that is persistently generated at regular intervals.

A voice over Internet protocol (VoIP) service is a representative example of the persistent data service. The VoIP service includes a protocol for transmitting voice traffic over an Internet protocol (IP) in the network layer, and a service using the same. In the VoIP service, a voice data frame is included in an IP packet and then transmitted to a receiving side over a packet communication network.

For example, the Third Generation Partnership Project (3GPP) Long Term Evolution (LTE) among mobile communication technologies supports packet communication only. Therefore, the VoIP that transmits voice data over the packet communication network is suitable for transmitting voice traffic over the LTE network.

In the VoIP traffic, a voice data packet is appropriately scheduled to be transmitted with a relatively short time interval (e.g., an interval of 20 ms). For data packet transmission between a mobile station and a base station, the base station should allocate a radio resource to the mobile station.

That is, the data packet transmission between the mobile station and the base station is performed in the following order. First, the mobile station requests scheduling from the base station, and then the base station accepts the request and allocates a radio resource to the mobile station. Then, the packet transmission between the base station and the mobile station can be performed through the allocated radio resource.

Conventionally, dynamic scheduling is used for allocating radio resources. However, when the radio resource is allocated by the dynamic scheduling, control information on a packet needs to be transmitted each time that a packet is transmitted. When the packet includes small-sized voice data, the control information is increased. Herein, the control information is an overhead for transmitting the voice data.

However, the size of control information that can be transmitted over a control channel is limited. Therefore, the number of information transmissions over the control channel is decreased as the size of control information on voice data that is transmitted to one mobile station (i.e., user) increases so that the number of concurrent mobile stations (users) on the wireless communication system is decreased.

To solve the above-stated problem in the dynamic scheduling, persistent scheduling is used for radio resource allocation in the 3GPP LTE standard. According to the persistent scheduling, packet transmission is performed as follows.

First, the mobile station requests scheduling from the base station only once so as to be allocated with a radio resource for a specific time period. Then, since the radio resource is fixedly allocated to the mobile station for the specific time period, control information on radio resource allocation is transmitted over the control channel only once when an initial data packet is transmitted thereto.

For example, when a radio resource is allocated for the VoIP service by the persistent scheduling, a voice data packet is transmitted with an interval of 20 ms. In this case, control information is not transmitted. However, a problem still exists when the radio resource allocation is performed by the persistent scheduling.

That is, when a series of packets with varying packet sizes are transmitted by the persistent scheduling, the packet size deviation cannot be efficiently controlled.

For example, when a radio resource is allocated with reference to a small size packet, a large packet cannot be transmitted so that a transmission error occurs. However, when the radio resource is allocated with reference to the largest packet to prevent the transmission error, transmission of a packet that is small compared to the allocated radio resource causes resource waste. Therefore, a wireless packet communication system that can solve the above-stated problems of the dynamic scheduling and the persistent scheduling in the persistent data service, and a radio resource allocation method thereof, have been continuously studied to improve radio resource efficiency.

The above information disclosed in this Background section is only for enhancement of understanding of the background of the invention and therefore it may contain information that does not form the prior art that is already known in this country to a person of ordinary skill in the art.

### DISCLOSURE

### Technical Problem

To solve the above-stated problems, the present invention has been made in an effort to provide a wireless packet communication system and a radio resource allocation method thereof having advantages of improving radio resource efficiency while reducing the size of resource allocation control information for packet transmission.

### Technical Solution

An exemplary wireless packet communication system according to one embodiment of the present invention provides a header-compressed transmission protocol. The wireless packet communication system includes a header compressor that compresses a packet header and generates a phase information signal including phase information of the corresponding packet.

An exemplary wireless packet communication system according to another embodiment of the present invention includes an allocation controller that reads phase information included in a packet header and determines a radio resource allocation method for the packet based on the phase information.

An exemplary base station according to another embodiment of the present invention determines a radio resource allocation method for a packet by using a wireless packet communication system that includes a header compressor and an allocation controller. The header compressor includes phase information of the packet included in a header of the packet, and compresses the packet header by using a header-compressed transmission protocol. The allocation controller reads the phase information of the packet and determines a radio resource allocation method for the packet based on the phase information.

In addition, an exemplary radio resource allocation method of a wireless packet communication system that uses a header-compressed transmission protocol according to another embodiment of the present invention includes determining a radio resource allocation method for a packet based on phase information of the packet read by an allocation controller.

### Advantageous Effects

The wireless packet communication system and the radio resource allocation method of the system according to the present invention can improve control channel efficiency by reducing the size of control information for packet transmission.

In addition, the improvement of the control channel efficiency increases the number of concurrent users.

Further, radio resource allocation is performed appropriately for the size of a packet to be transmitted so that efficiency in the use of radio resource allocated by persistent scheduling can be improved.

### DESCRIPTION OF DRAWINGS

FIG. 1 is a block diagram of a wireless packet communication system according to an exemplary embodiment of the present invention.

FIG. 2 shows a relationship between the size and the phase of a packet generated in a header compressor in the wireless packet communication system according to the exemplary embodiment of the present invention.

FIG. 3 is a flowchart of a radio resource allocation method of a wireless communication system according to a first exemplary embodiment of the present invention.

FIG. 4 shows a packet transmission process between a base station and a mobile station by using the radio resource allocation method of FIG. 3.

FIG. 5 is a flowchart of a radio resource allocation method of a wireless communication system according to a second exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification. In addition, unless explicitly described to the contrary, the word “comprise” and variations such as “comprises” or “comprising”, will be understood to imply the inclusion of phased elements but not the exclusion of any other elements.

In addition, the terms “-er”, “-or” and “module” described in the specification mean units for processing at least one function and operation and can be implemented by hardware components or software components, and combinations thereof.

Throughout the specification, a mobile station (MS) represents a terminal, a mobile terminal (MT), a subscriber station (SS), a portable subscriber station (PSS), user equipment (UE), and an access terminal (AT), and includes entire or partial functions of the mobile terminal, subscriber station, portable subscriber station, and user equipment.

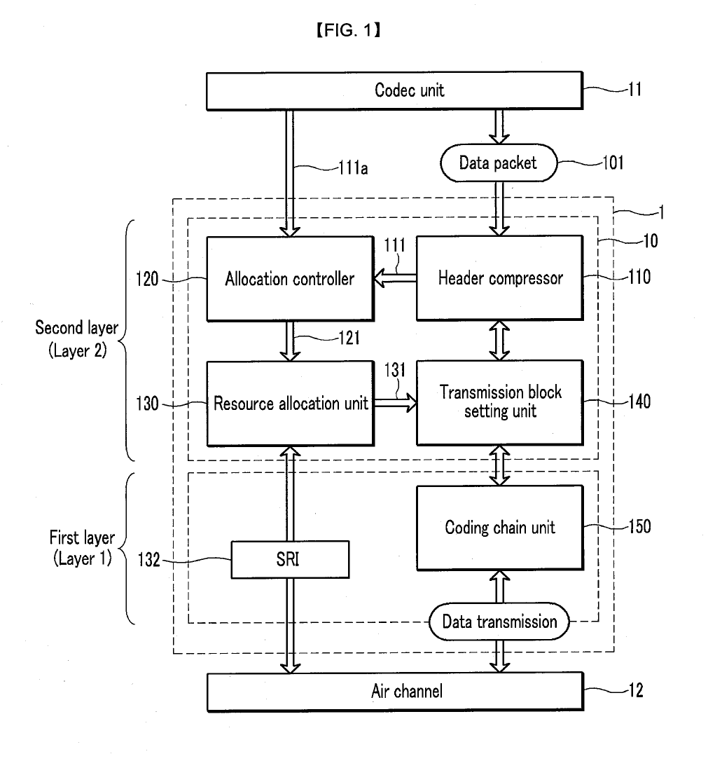

A base station (BS) represents an access point (AP), a radio access station (RAS), a node B (Node-B), a base transceiver station (BTS), and a mobile multihop relay (MMR)-BS, and includes entire or partial functions of the AP, RAS, Node-B, BTS, and MMR-BS. FIG. 1 is a block diagram of a wireless packet communication system according to an exemplary embodiment of the present invention.

As shown in FIG. 1, a wireless packet communication system 10 according to the exemplary embodiment of the present invention includes a header compressor 110 and an allocation controller 120.

The wireless packet communication system 10 according to the exemplary embodiment of the present invention may further include a resource allocation unit 130.

In addition, the wireless packet communication system 10 according to the exemplary embodiment of the present invention may further include a transmission block setting unit 140. The header compressor 110 compresses a header of a data packet 101 transmitted from a codec unit 11. The header compressor 110 transmits current phase information on the data packet 101 to the allocation controller 120.

In a persistent service like a voice over Internet protocol (VoIP) service, a packet size is changed primarily for two reasons. First, when a source application (e.g., voice AMR codec, etc.) has a characteristic of generating various-size packets, the packet size is changed. In general, a voice codec is designed to generate packets of data of variable sizes according to conditions. Accordingly, the data packet generated by the voice codec has a variable size. Second, when header compression is performed on the data packet, the packet size is changed.

In a packet data convergence protocol (PDCP), a packet header is compressed in order to improve transmission efficiency in a radio section. In general, a 40 byte header is compressed to 2 to 7 bytes after compression is performed. When the data packet size is large, header compression does not have a great influence on the radio resource efficiency.

However, when the header compression is performed on a small data packet (e.g., a voice data packet), the header compression rate has a great influence on the packet size. In the case that a packet is generated by the PDCP, the packet size is related to time lapse.

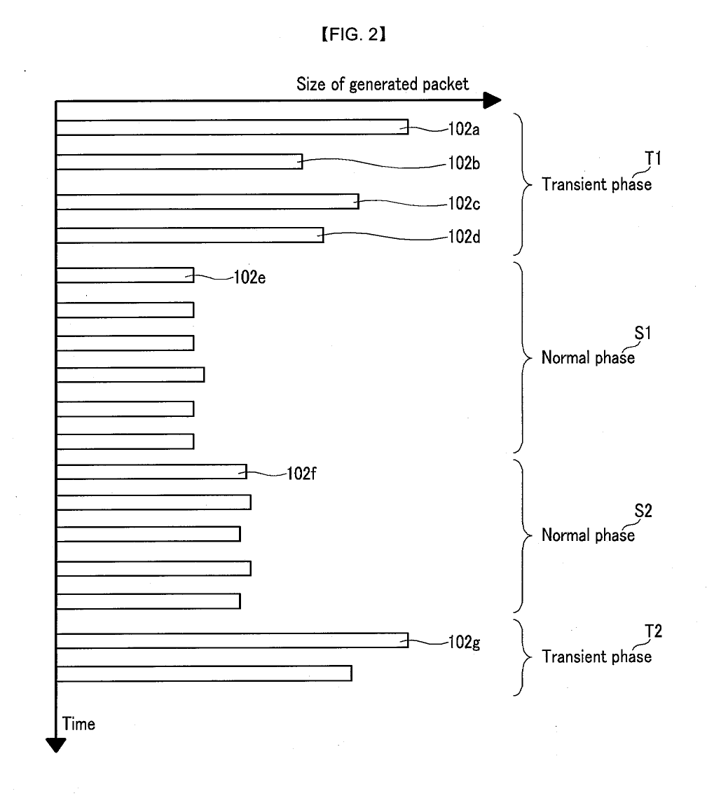

FIG. 2 shows a relationship between the size and the phase of a packet generated by the header compressor of the wireless packet communication system according to the exemplary embodiment of the present invention.

As shown in FIG. 2, a header of a packet that is initially generated after radio resource allocation is transmitted to a mobile station without being compressed by the header compressor 110. The header compressor 110 starts to compress a packet header after packet transmission is performed several times.

In accordance with the number of sub-phases defined by a header compression algorithm applied to the header compressor 110, one of phase information among a plurality of phase information, each having a different header compression rate, is designated to the corresponding packet. The phase information is included in a header of the corresponding packet. When the header compression is not performed, size deviation between each of a series of packets output from the header compressor 110 is great.

According to the exemplary embodiment of the present invention, a phase during which packet size variation is great is referred to as a transient phase. As time passes, each packet header is compressed with a pattern of similar compression rate, and accordingly, similar-sized short packets are continuously generated.

Such a phase during which similar-sized short packets having a similar compression rate are continuously generated is referred to as a steady phase according to the exemplary embodiment of the present invention.

The description of the wireless packet communication system 10 will now be continued with reference to FIG. 1.

The header compressor 110 transmits current phase information of the data packet 101 to the allocation controller 120. The allocation controller 120 may receive a phase information signal 111 from the header compressor 110, and may receive a phase information signal 111a from the codec unit 11 of the data packet 101. The phase information signal 111 or 111a transmitted from the header compressor 110 or the codec unit 11 to the allocation controller 120 includes unique phase information of the data packet 101 that is currently generated according to a header compression algorithm applied to the header compressor 110.

Through the above-described process, the allocation controller 120 reads phase information stored in a header of the packet 101. The allocation controller 120 checks the phase of the corresponding packet with reference to the phase information signal 111 or 111a, and then requests an appropriate radio resource allocation method that corresponds to the phase from the resource allocation unit 130.

The allocation controller 120 transmits an allocation request signal 121 for the request to the resource allocation unit 121. The header compressor 110 may use various header compression algorithms.

For example, the unique phase may be defined as A1, A2, and A3 when an “A” compression algorithm is used. In addition, the unique phase may be defined as B1, B2, B3, B4, and B5 when a “B” compression algorithm is used. The allocation controller 120 stores a radio resource allocation method corresponding to each of unique phases according to a header compression algorithm applied to the header compressor 110 of the wireless communication system 10.

For example, it is assumed that packet size varies from 10 to 100 bytes when the header compressor 110 uses a specific algorithm (i.e., the “A” algorithm). In addition, it is assumed that a first normal phase is defined as a phase during which the packet size is uniform between 10 to 50 bytes and a second normal phase is defined as a phase during which the packet size is uniform between 50 to 100 bytes by the allocation controller 120.

The allocation controller 120 determines whether the packet transmission phase is the transient phase, the first normal phase, or the second normal phase with reference to the phase information (i.e., A1, A2, or A3) transmitted from the header compressor 110. When the allocation controller 120 determines that the packets (i.e., 102a to 102d of FIG. 2) are in the transient phase (i.e., T1 of FIG. 2), the allocation controller 120 requests the resource allocation unit 130 to allocate radio resources to the corresponding packet according to dynamic scheduling.

Accordingly, control information for radio resource allocation for the corresponding packet is transmitted from a base station to a mobile station over an additional control channel. In addition, the corresponding packet is transmitted through an allocation radio resource. In the case that a packet (e.g., 102e of FIG. 2) is in the first normal phase (i.e., S1 of FIG. 2), the allocation controller 120 requests the resource allocation unit 130 to perform persistent scheduling so as to allocate a radio resource with a size of 50 (the size can be 50+payload according to exemplary embodiments).

Accordingly, control information is transmitted only once from the base station to the mobile station for radio resource allocation before an initial packet (i.e., 102e) in the first normal phase (i.e., S1 of FIG. 2) is transmitted. In the case that the packet (i.e., 102f of FIG. 2) has phase information that corresponds to the second normal phase (i.e., S2 of FIG. 2), the size of the radio resource should be changed to 100 (the size of the packet can be 100+payload according to exemplary embodiments).

Therefore, the allocation controller 120 requests the resource allocation unit 130 to perform continuous scheduling for allocating the changed radio resource to the corresponding packet. In addition, control information on radio resource allocation is transmitted to the mobile station from the base station before the initial packet (i.e., 102f in FIG. 2) in the second normal phase (i.e., S1 of FIG. 2) is transmitted.

When the packet (i.e., 102g of FIG. 2) has phase information that corresponds to the transient phase (i.e., T2 of FIG. 2), the allocation controller 120 requests the resource allocation unit 130 to transmit the corresponding data packet by performing dynamic scheduling.

Accordingly, each time that the packet is transmitted due to the characteristic of the dynamic scheduling allocation, control information for transmission of the corresponding packet is transmitted to the mobile station through an additional control channel. The control information includes the size of a radio resource allocated to a header and a resource address.

Since a radio resource with appropriate size can be allocated to a packet according to the current phase of the packet only by checking phase information from the header compressor, the radio resource can be efficiently used even though persistent scheduling is performed.

In addition, the control channel can be more efficiently used compared to the case of performing only the dynamic scheduling allocation. In this case, an increase of the number of multiple access users can be expected. The resource allocation unit 130 allocates a radio resource to the corresponding packet 101 by using a scheduling algorithm that suitably corresponds to the allocation request signal 121 transmitted from the allocation controller 120.

After allocating the radio resource, the resource allocation unit 130 transmits a transmission request signal 131 to a transmission block setting unit 140 so as to request the transmission block setting unit 140 to transmit the packet 101. The transmission block setting unit 140 receives the transmission request signal 131 and transmits a data packet to the physical layer (the first layer: Layer 1). In the physical layer, the corresponding packet is transmitted to an air channel 12 through a coding chain unit 150, and is finally transmitted to the mobile station over the air channel 12.

When the packet is in the transient phase or is the initial packet in the normal phase, control information is transmitted to the mobile station through the control channel for the packet transmission. From the second packet in the normal phase, packet transmission is performed without transmitting the control information. As a part of a base station 1, the wireless packet communication system 10 according to the exemplary embodiment of the present invention determines a radio resource allocation method for a specific packet in the base station 1.

In this specification, the exemplary embodiments are applied to a downlink, but the exemplary embodiments of the present invention can be applied to an uplink in the same manner as to the downlink.

However, in order to apply exactly the same method to the uplink, a scheduling request indication (SRI) 132 should transmit the current phase information of the mobile station (i.e., user equipment, UE) to the base station. In addition, in order to reduce SRI signal delay or overhead, relevant information can be transmitted by including the information in a header of a packet that is transmitted to the uplink.

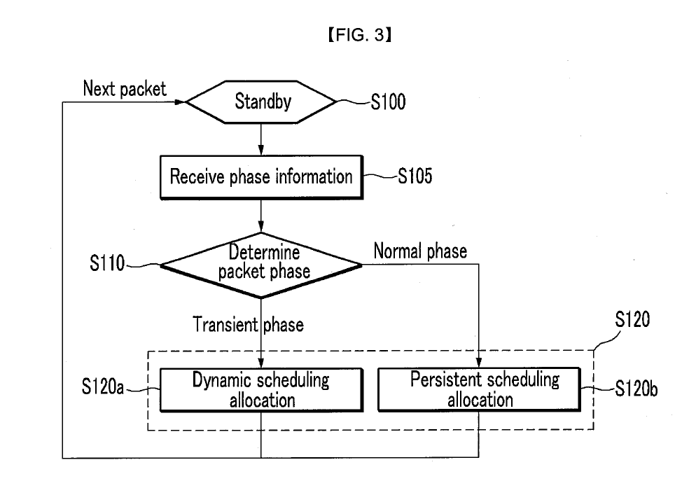

FIG. 3 shows a flowchart of a radio resource allocation algorithm of a wireless communication system according to a first exemplary embodiment of the present invention.

As shown in FIG. 3, the radio resource allocation algorithm of a wireless communication system according to the first exemplary embodiment of the present invention includes step S110 for determining a packet phase and step S120 for allocating a radio resource by using a scheduling method that corresponds to the packet phase.

In step S110 of determining the packet phase, an allocation controller, which is a sub-layer that is included within the second layer (Layer 2) of the wireless communication system and supports a radio resource allocation packet, determines whether the current phase of the packet is the transient phase or the normal phase. The allocation controller determines the packet phase based on a phase information signal of the current packet, which is transmitted to the allocation controller from a header compressor that is a sub-layer that is included within the second layer and compresses a packet header.

Therefore, the radio resource allocation algorithm further includes step S105 for transmitting a current packet phase information signal from the allocation controller to the header compressor before determining the current packet phase in step S110. Step S120 for allocating a radio resource to the corresponding packet is performed subsequent to the step S110.

The step S120 of allocating the radio resource will now be described in further detail. When the allocation controller determines that the packet is in the transient phase, the allocation controller transmits a signal to request the radio resource allocation unit to transmit the corresponding data packet by using dynamic scheduling.

The resource allocation unit is a sub-layer that allocates radio resources, and is included in the second layer (Layer 2) in the wireless communication system performing dynamic scheduling. Then, control information that includes the size and an address of the radio resource allocated to the radio resource is transmitted to the mobile station over an additional control channel (S120a).

When the allocation controller determines that the packet is in the normal phase, the allocation controller transmits a request signal to the resource allocation unit so as to request the resource allocation unit to allocate a radio resource having a size that corresponds to the normal phase by persistent scheduling and transmit the data packet.

In addition, control information only for the initially generated packet is transmitted to the mobile station over the additional control channel. From the second packet, control information on the corresponding packet is not transmitted and only the packet is transmitted to the mobile station through the fixedly allocated radio resource (S120b).

Accordingly, control channel efficiency is improved, thereby increasing the number of concurrent users. After the step S120 of allocating the radio resource, radio resource allocation for packet transmission for the next packet is sequentially performed from the step S100.

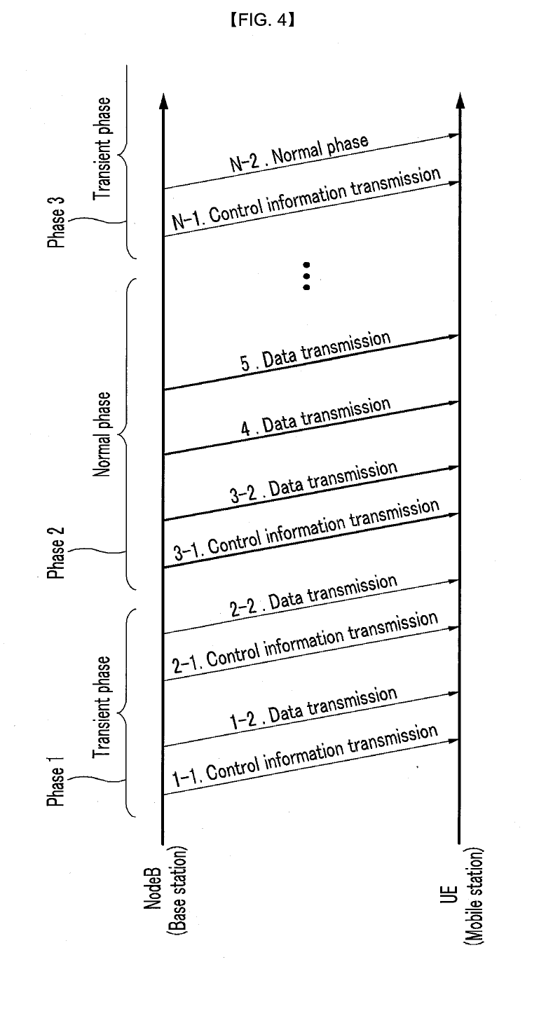

FIG. 4 shows a packet transmission process between the base station and the mobile station according to the radio resource allocation method of FIG. 3.

In FIG. 4, the phase of a packet transmitted from the base station to the mobile station through a downlink is changed from a transient phase (i.e., Phase 1) to a transient phase (Phase 3) after a normal phase (Phase 2). In the transient phase (Phase 1), control information for allocating a radio resource to a packet is transmitted from the base station (Node B) to the mobile station (UE) (1-1). In addition, a voice data packet is transmitted to the mobile station by using the radio resource allocated to the packet (1-2).

For the next packet in the transient phase (Phase 1), control information for the corresponding packet is transmitted over the control channel (2-1), and a voice data packet is transmitted by using a radio resource allocated to the packet (2-2).

When the packet phase is determined to be the normal phase, resource allocation for packet transmission is performed by persistent scheduling allocation (Phase 2). In this case, control information only for the initial packet transmitted by the persistent scheduling allocation is transmitted to the mobile station through the control channel for radio resource allocation to the packet (3-1). While the normal phase (Phase 2) is maintained, the next sequential packets (4, 5, . . . ) are transmitted without transmitting additional control information.

When the packet phase is determined to be changed to a transient phase (Phase 3), each packet is transmitted from the base station to the mobile station by the dynamic scheduling allocation as in the previous transient phase (Phase 1).

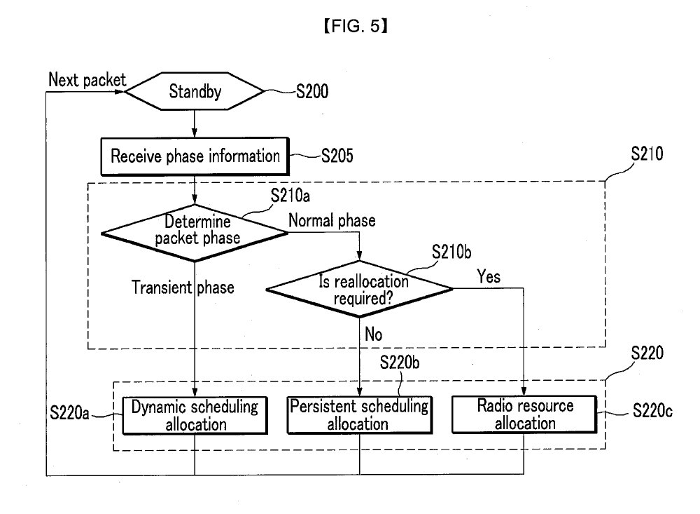

FIG. 5 is a flowchart of a radio resource allocation method of a wireless communication system according to a second exemplary embodiment of the present invention. Unlike in the first exemplary embodiment, a plurality of normal phases are defined in the first exemplary embodiment.

When a packet is in the normal phase, that is, when a packet is transmitted by the persistent scheduling allocation, the size of a radio resource for transmitting the packet should be changed for some cases. In this case, the normal phase is changed to the transient phase and then variable scheduling allocation or persistent scheduling allocation is performed so that a problem of allocating an excessive radio resource compared to the packet occurs according to the first exemplary embodiment of the present invention.

Therefore, a plurality of normal phases are set so that the number of radio resources can be changed while maintaining the persistent scheduling allocation, according to the second exemplary embodiment of the present invention.

Referring to FIG. 5, the flow of the radio resource allocation method of the wireless communication system according to the second exemplary embodiment of the present invention will now be described.

According to the second exemplary embodiment of the present invention, the radio resource allocation method of the wireless communication system includes step S210 of determining a packet phase and step S220 of allocating a radio resource according to a scheduling method that corresponds to the packet phase. In addition, a step of transmitting a phase information signal of a current packet is further included before the step S210.

In the step S210 of determining the packet phase, the packet phase is determined through two determination steps. That is, the allocation controller first determines whether the packet is in the transient phase or in the normal phase (S210a). When the packet is in the normal phase, whether a sub-phase of the corresponding packet requires radio resource reallocation or not is determined (S210b). When the packet is in the normal phase and the sub-phase of the packet does not require radio resource reallocation, packet transmission is performed by the persistent scheduling allocation (S220b).

However, when the packet is in the normal phase and the sub-phase of the packet requires the radio resource allocation, control information for the reallocation is transmitted over the control channel to the mobile station (S220c). Therefore, by variously defining a plurality of normal phases, radio resource allocation is performed in proportion to the packet size while maintaining the persistent scheduling allocation so that the radio resource can be efficiently used.

After the step S220 of allocating the radio resource, radio resource allocation for the next packet is performed for sequential packet transmission from the step S200. The present invention is not limited to the VoIP service and can be applied to various persistent data services having similar packet characteristics.

In order words, the wireless communication system and the radio resource allocation method of the system according to the exemplary embodiments of the present invention can be applied to a wireless communication service that has a relatively short radio resource allocation cycle and requires a large amount of control information to be transmitted to a mobile station for radio resource allocation.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A wireless packet communication system using a header-compressed transmission protocol, the wireless packet communication system comprising
a header compressor compressing a packet header and generating a phase information signal that includes phase information of the corresponding packet.

2. The wireless packet communication system of claim 1, wherein the phase information corresponds to one of a plurality of unique phases defined by a header compression algorithm used by the header compressor.

3. The wireless packet communication system of claim 2, further comprising an allocation controller that receives the phase information signal.

4. The wireless packet communication system of claim 3, wherein the allocation controller that determines a radio resource allocation method for the packet based on the phase information signal.

5. The wireless packet communication system of claim 4, wherein the allocation controller generates a first allocation request signal for allocating the radio resource to the packet by using dynamic scheduling when the phase information is first phase information that corresponds to the dynamic scheduling.

6. The wireless packet communication system of claim 5, wherein the allocation controller generates a second allocation request signal for allocating the radio resource to the packet by using persistent scheduling when the phase information is second phase information that corresponds to the persistent scheduling.

7. The wireless packet communication system of claim 6, further comprising a resource allocation unit that receives the first allocation request signal or the second allocation request signal from the allocation controller and allocates the radio resource to the packet.

8. The wireless packet communication system of claim 7, wherein the resource allocation unit allocates the radio resource to the packet by using the dynamic scheduling when receiving the first allocation request signal from the allocation controller.

9. The wireless packet communication system of claim 8, wherein the resource allocation unit allocates the radio resource to the packet by using the persistent scheduling when receiving the second allocation request signal from the allocation controller.

10. The wireless packet communication system of claim 9, wherein the phase information is the first phase information, and control information of the packet is transmitted over a control channel to a mobile station to which the packet is transmitted.

11. A wireless packet communication system using a header-compressed transmission protocol, the wireless packet communication system comprising an allocation controller that reads packet phase information included in a packet header and determines a method for allocating a radio resource to the packet on the basis of the phase information.

12. The wireless packet communication system of claim 11, further comprising a header compressor that includes the phase information in the packet header and compresses the packet header.

13. The wireless packet communication system of claim 12, wherein the phase information corresponds to one of a plurality of unique phases defined by a header compression algorithm used by the header compressor.

14. The wireless packet communication system of claim 13, wherein the allocation controller generates a first allocation request for allocating the radio resource to the packet by using dynamic scheduling when the phase information is first phase information that corresponds to the dynamic scheduling.

15. The wireless packet communication system of claim 14, wherein the allocation controller generates a second allocation request signal for allocating the radio resource to the packet by using persistent scheduling when the phase information is second phase information that corresponds to the persistent scheduling.

16. (canceled)

17. A radio resource allocation method of a wireless packet communication system that uses a header-compressed transmission protocol, the radio resource allocation method comprising
determining a radio resource allocation method for a packet based on phase information of the packet read by an allocation controller.

18. The radio resource allocation method of claim 17, further comprising reading the phase information of the packet by the allocation controller before determining the radio resource allocation.

19. The radio resource allocation method of claim 18, wherein the phase information corresponds to one of a plurality of unique phases defined by a header compression algorithm used by the header compressor.

20. The radio resource allocation method of claim 19, wherein the radio resource is allocated to the packet by dynamic scheduling when the phase information is first phase information that corresponds to the dynamic scheduling.

21. The radio resource allocation method of claim 20, wherein the radio resource is allocated to the packet by persistent scheduling when the phase information is second phase information that corresponds to the persistent scheduling.
